(19) United States
(12) Patent Application Publication
(10) Pub. No.: US 2023/0267363 A1
(43) Pub. Date: Aug. 24, 2023

(54) MACHINE LEARNING WITH PERIODIC DATA

(71) Applicant: Lemon Inc., Grand Cayman (KY)

(72) Inventors: Yingxiang YANG, Los Angeles, CA (US); Tianyi LIU, Los Angeles, CA (US); Taiqing WANG, Los Angeles, CA (US); Chong WANG, Los Angeles, CA (US); Zhihan XIONG, Los Angeles, CA (US)

(21) Appl. No.: 17/666,076

(22) Filed: Feb. 7, 2022

(51) Int. Cl. G06N 20/00; G06F 17/14

(52) U.S. Cl. CPC G06N 20/00; G06F 17/14

(57) ABSTRACT

Embodiments of the present disclosure relate to machine learning with periodic data. According to embodiments of the present disclosure, a feature representation of an input data sample is obtained from a prediction model. First Fourier coefficients for a first component in a Fourier expansion are determined by applying the feature representation into a first mapping model, and second Fourier coefficients for a second component in the Fourier expansion are determined by applying the feature representation into a second mapping model. A Fourier expansion result is determined based on the first Fourier coefficients and the second Fourier coefficients in the Fourier expansion, and a prediction result for the input data sample is determined based on the Fourier expansion result.

### BACKGROUND

Periodic or cyclic data are frequently encountered in a wide range of machine learning scenarios. For example, in recommender systems, it is observed that users may usually log in an application within a relatively fixed time window each day (e.g. before bed or after work), resulting in a strong cyclical pattern in the recommendations to the users. In financial markets, asset prices may rise and fall periodically on a yearly basis, a phenomenon commonly known as “seasonality.” In search engines, the hits of certain keywords can also display periodic patterns. How to exploit the periodicity within training data to learn a better prediction model is thus an important issue for those applications.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIG. 1 illustrates a block diagram of an environment in which the embodiments of the present disclosure can be implemented;

FIG. 2 illustrates a block diagram of a machine learning system with Fourier learning in accordance with some example embodiments of the present disclosure;

FIG. 3 illustrates a block diagram of a machine learning system with Fourier learning in accordance with some other example embodiments of the present disclosure;

FIG. 4 illustrates a block diagram of a machine learning system with Fourier learning in accordance with some further example embodiments of the present disclosure;

FIG. 5 illustrates a diagram of an example algorithm for Fourier learning with pseudo gradient descent in accordance with some embodiments of the present disclosure;

FIG. 6 illustrates a flowchart of a process for Fourier learning in accordance with some example embodiments of the present disclosure; and

FIG. 7 illustrates a block diagram of an example computing system/device suitable for implementing example embodiments of the present disclosure.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used herein, the term “model” is referred to as an association between an input and an output learned from training data, and thus a corresponding output may be generated for a given input after the training. The association may be represented by a function, which processes the input and generates the output. The generation of the model may be based on a machine learning technique. The machine learning technique may also be referred to as artificial intelligence (AI) technique. In general, a machine learning model can be built, which receives input information and makes a prediction based on the input information. Such a machine learning model may be referred to as a prediction model. For example, a classification model may predict a class of the input information among a predetermined set of classes, a recommendation model may predict a recommendation result to a user based on context information related to the user, a model applied in a search engine may predict a probability of the hits of a certain keyword based on user behaviors. As used herein, “model” may also be referred to as “machine learning model”, “learning model”, “machine learning network” or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. At the application stage, the resulting machine learning model may be used to process an actual model input based on the set of parameter values obtained from the training process and to determine the corresponding model output.

Online machine learning is a method of machine learning in which training data becomes available in a sequential order and is used to update the optimal machine learning model for future data at each step, as opposed to batch learning techniques which generate the optimal machine learning model by learning on the entire training data set at once.

### Example Environment

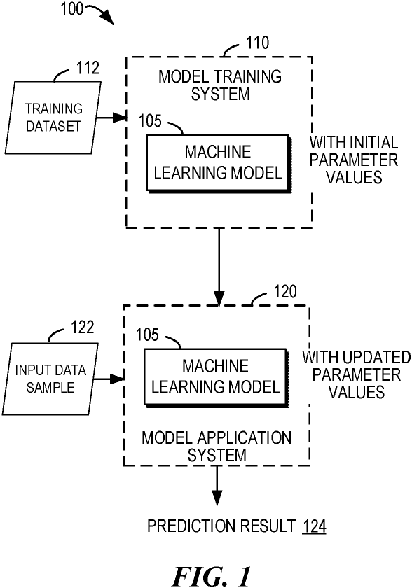

As mentioned above, it is expected to exploit the periodicity within training data to learn a better prediction model. A prediction model is constructed and utilized according to machine learning techniques. Reference is made to FIG. 1 to describe an environment of machine learning.

FIG. 1 illustrates a block diagram of an environment 100 in which embodiments of the present disclosure can be implemented. In the environment 100, it is expected to train and apply a machine learning model 105 for a prediction task. The machine learning model 105 may be of any machine learning or deep learning architectures, for example, a neural network.

In practical systems, the machine learning model 105 may be configured to process an input data sample and generate a prediction result for the input data sample. The prediction task may be defined depending on practical applications where the machine learning model 105 is applied. As an example, in a recommendation system, the prediction task is to predict one or more items or objects which a user is of interest and provide a recommendation to the user based on the prediction. In this example, the input data sample to the machine learning model 105 may comprise context information related to the user such as user information, historical user interactions, and so on, and information related to items to be recommended. The output from the machine learning model 105 is a prediction result indicating which items or which types of items the user may be of interest. As another example, in a financial application, the prediction task is to predict the sales of a product at a further time. In this example, the input data sample to the machine learning model 105 may comprise the further time, information related to the product and/or other related products, historical sales of the product and/or other related products, information related to target geographical areas and target users of the product, and so on. It would be appreciated that only a limited number of examples are listed above, and the machine learning model 105 may be configured to implement any other prediction tasks.

The machine learning model 105 may be constructed as a function which processes input data and generates an output as a prediction result. The machine learning model 105 may be configured with a set of parameters whose values are to be learned from training data through a training process. In FIG. 1, the model training system 110 is configured to implement a training process to train the machine learning model 105 based on a training dataset 112. At an initial stage, the machine learning model 105 may be configured with initial parameter values. During the training process, the initial parameter values of the machine learning model 105 may be iteratively updated until a learning objective is achieved.

The training dataset 112 may include a large number of input data samples provided to the machine learning model 105 and labeling information indicating corresponding groundtruth labels for the input data samples. In some embodiments, an objective function is used to measure the error (or distance) between the outputs of the machine learning model 105 and the groundtruth labels. Such an error is also called a loss of the machine learning, and the objective function may also be referred to as a loss function. The loss function may be represented as ℓ(ƒ(x),y),where x represents the input data sample, ƒ() represents the machine learning model, ƒ(x) represents an output of the machine learning model, and y represents a groundtruth label for x. During training, the parameter values of the machine learning model 105 are updated to reduce the error calculated from the objective function. The learning objective may be achieved until the objective function is optimized, for example, until the calculated error is minimized or reaches a desired threshold value.

After the training process, the trained machine learning model 105 configured with the updated parameter values may be provided to the model application system 120 which applies a real-world input data sample 122 to the machine learning model 105 to output a prediction result 124 for the input data sample 122.

In FIG. 1, the model training system 110 and the model application system 120 may be any systems with computing capabilities. It should be appreciated that the components and arrangements in the environment shown in FIG. 1 are only examples, and a computing system suitable for implementing the example implementation described in the subject matter described herein may include one or more different components, other components, and/or different arrangement manners. For example, although shown as separate, the model training system 110 and the model application system 120 may be integrated in the same system or device. The embodiments of the present disclosure are not limited in this respect.

In some cases, input data processed by a machine learning model may be of a certain periodicity. Such data is called periodic or cyclic data. For examples, users of an application may usually log in the application within relatively fixed time windows each day (e.g. before bed and after work) and show the same interest at the same time window on different days. Such a cyclical pattern may lead to different predicting recommendations to the users. As such, it is expected that the machine learning model 105 may be trained to exploit the periodicity within the training data.

The problem of exploiting the periodicity within training data to learn a better prediction model may be set up as follows. Given samples denoted by a triplet (x, y, t), with x ∈X⊂ ℝ^{d} being the feature of an input data sample, y ∈ y ⊆ ℝ being a prediction result for the input data sample, and t ∈ℝ being the point of time at which the input data sample is generated, it is expected to learn a prediction model (represented as f ∈ F) that can predict y with x for any given point of time t. The data samples may arrive in a cyclical fashion. More specifically, between two consecutive updates of the model at t and t+δ, only samples arrived at the interval [t, t+δ) is available for training. In addition, if (x, y) is generated from a time-dependent distribution Dₜ, then there exists a periodicity of T such that Dₜ = D_{t-T} for all t. Under the further assumption that, for any (x, y, t), the triplet (x, y, mod(t, T)) is sampled from a joint distribution p(mod(t,T))D_{mod(t,T)} (x,y), the goal is to solve the following set of optimization problems for the loss function ℓ(ƒ(x),y):

$${f}_{t}^{*} \left(x\right) ∈ {\text{argmin}}_{f ∈ {L}_{2} \left(X\right)} {E}_{x , y ∼ {D}_{t}} \left[l \left(f \left(x\right) , y\right)\right] ∀ t ∈ ℝ \qquad \text{(1)}$$

It is assumed that X and y are convex and compact sets, and the loss function ℓ(ƒ(x),y) is strongly convex with respect to f for all y ∈ Y. The above set of optimization problems in Equation (1) may be solved by learning a set of finite-energy and continuous functions

$${f}_{t}^{*} \left(x\right)$$

(which represents the expected prediction model) to minimize the expected loss for each point of time t ∈ ℝ. The optimization is conducted within the space

$${L}_{2} ( X ) = \left\{f : X \to ℝ \vert \int {}_{x} {f}^{2} ( x ) d x < ∞\right\}$$

, which is a function space that contains all finite-energy functions defined over X.

The concept of periodicity plays an important role in Equation (1). Specifically, due to periodicity, a function

$${f}_{t}^{*} \left(x\right)$$

for the point of time t is also guaranteed to be a solution at t+nT (where n is an integer larger than zero). This implies that the prediction model learned at time t may offer useful information to improve the prediction accuracy at t+nT. Hence, the inventors are motivated to design a learning algorithm that can effectively exploit such useful information offered by the cyclical nature of the data.

Surprisingly, existing optimization and machine learning techniques offer little insight on how to exploit periodicity within training data to solve Equation (1) efficiently under a big-data setting, whereas industrial systems implement algorithms that simply underrate the periodicity within the training data.

When faced with machine learning on periodic data, one straight-forward design to encode periodicity into the model structure is to simply include t as a model input and learn a function ƒ(x,t). Unfortunately, this approach does not work out-of-the-box. When the function ƒ(x,t) is represented as a machine learning model, it has been shown that it fails to learn periodicity unless using special activation functions. When ƒ(x,t) belongs to a non-parametric family that encodes periodicity, such as a reproducing kernel Hilbert space (RKHS) with a periodic kernel or a Sobolev-Hilbert space with a periodic spline, the periodicity is automatically encoded across all input dimensions, whereas in Equation (1) f(x, t) may be aperiodic in x.

An enhanced version of this approach is to pre-process the time t and learn a function represented as ƒ (x, mod(t, T)) instead, which focuses on a single period of ƒ (x, t). Although the pre-processing of t into mod(t,T) guarantees periodicity during the inference stage, it still often requires laborious feature engineering, especially when x is high-dimensional and ƒ(x, t) has a complicated design.

Another approach to Equation (1) is to simply learn a prediction model for every t. This is often practically impossible, and hence the time axis is often discretized so that the learner only needs to learn a finite set of models for several discretized points of time, resulting in a pluralistic approach. For machine learning systems, this set of models can share a “base” part of a neural network, and differ only in the last few layers. On the positive side, when the time-dependent distribution Dₜ is piece-wise constant in time, e.g.,

$${D}_{t} = {D}_{0} 1 \left[0 \leq mod ( t , T ) < T / 2\right] + {D}_{1} 1 \left[T / 2 \leq mod ( t , T ) < T\right]$$

, this approach allows each separate model to converge to its optimal as the time t/T → ∞. On the other hand, however, this pluralistic approach requires storing multiple models, which is hard to scale for large-scale industrial systems that often cost terabytes of memory space to store. Although computationally efficient methods exist, e.g., partially sharing the network structure between the models, they typically compromise the theoretical guarantees as a trade-off.

A further solution for training prediction models using sequential data is to follow the online learning protocol, where newly-generated periodic data are applied to optimize the model. The performance of the learning algorithm is typically evaluated using the concept of dynamic regret, which measures the model’s capability to consistently and accurately predict the labels of the latest batch of arriving data. Crudely speaking, when t takes a set of discretized values, the dynamic regret measures

$${\sum }_{t} E \left[l \left({f}_{t} \left(x\right) , y\right) - l \left({f}_{t}^{*} \left(x\right) , y\right)\right] ,$$

the cumulative sum of the differences between the loss under the learned model and the optimal loss under

$${f}_{t}^{*} \left(x\right)$$

defined in Equation (1). Although many optimization algorithms have been proposed to improve the dynamic regret analysis, none of them shed light on how to exploit periodicity within the training data. What is more, when Dₜ does not converge to a fixed distribution as t diverges, the dynamic regret scales linearly in t, implying that the gap between the learned model and the desired optimal does not vanish even when the data is known to be cyclical.

In summary, the problem of exploiting the cyclical pattern in data distributions to train a better model remains largely an open problem in a large-scale setting.

### Work Principle and Theory Analysis

According to embodiments of the present disclosure, there provides an improved solution to address the challenges of machine learning with cyclical data. This solution proposes a new learning framework, called Fourier learning. Fourier learning can be applied in learning a prediction model for use in various applications where periodic data are generated.

Before describing the applying of Fourier learning within a prediction model, it is first analyzed and proved theoretically how the Fourier learning can solve the problem of exploiting the periodicity within training data to learn a better prediction model, e.g., the optimization problem in Equation (1).

In embodiments of the present disclosure, the proposed Fourier learning can solve the set of optimization problems in Equation (1) as a single optimization problem in a function space that naturally contains time-periodic functions. In particular, the function space may be a tensor product of two Hilbert spaces, one contains model snapshots at a fixed point in time, while the other contains time-periodic functions. As will be demonstrated below, it turns out that this leads to a partial Fourier expansion for these functions. Under a convex analysis setting, it is also possible to learn the Fourier coefficients using streaming-stochastic gradient descent (SGD). Theoretically, the proposed Fourier learning framework can be supported from two different aspects: (i) from a modeling perspective, the Fourier learning is naturally derived from a functional optimization problem that is equivalent to the optimization problem in Equation (1) under a strongly convex and a realizable setting; (ii) in terms of optimization, it is demonstrated that the coefficient functions updated with streaming-SGD provably converge in the frequency domain. For practical applications, the Fourier learning can be integrated to various prediction models, to allow the prediction models to provide more accurate prediction results. By integrating with the Fourier learning, one single model framework may be sufficient for predictions of periodic data.

The theoretical foundations for the proposed Fourier learning is first introduced, which can be derived as a natural solution to a function optimization problem. In embodiments of the present disclosure, the set of learning problems in Equation (1) is reformulated as one single learning problem in a Hilbert space. In practice, this will allow to learn a unified model that takes both x and t as its inputs. Specifically, the learning objective takes the form of Equation (2) below, where the expectation can be replaced by the empirical mean over datasets in practice:

$${min}_{f ∈ H} L \left(f\right) : = {E}_{x , y , t ∼ {D}_{t} \left(x , y\right) p \left(t\right)} \left[l \left(f \left(x , t\right) , y\right)\right] . \qquad \text{(2)}$$

In Equation (2), ƒ(x, t) is a model to be learned to exploit the periodicity of input data x generated at a point of time t, y is the groundtruth label for x, the triplet (x, y, ) is generated from a time-dependent distribution Dₜ (x,y) p( t), where Dₜ (x,y) is the distribution of (x, y), and p(t) is the distribution of the point of time t (e.g., p(t) = 1/T) for t ∈[0,T]. According to Equation (2), it is expected to find, from a Hilbert Space

$$H$$

, a model ƒ(x, t) that can minimize a loss function ℓ(ƒ(x, t), y) whose loss is calculated between the prediction result from the model ƒ(x,t) and the groundtruth label y.

An important element in Equation (2) is the design of Hilbert Space

$$H$$

in which ƒ(x,t) is searched for. For the problem of learning with cyclical data, it is particularly focused on functions in a Hilbert Space that are continuous, periodic in time, and have a finite energy in a single period of time. The inventors have found that the unified objective in Equation (2) is related to Equation (1) via the following Lemma 1. Lemma 1. For

$${f}_{t}^{*} \left(x\right)$$

in Equation (1), let

$${f}_{0} \left(x , t\right) = {f}_{t}^{*} \left(x\right) ∀ t ∈ ℝ .$$

If

$${f}_{0} ( x , t ) ∈ H , t h e n {f}_{0} ( x , t )$$

minimizes the loss function L(ƒ) in

$$H$$

.

In Lemma 1, T represents the periodicity of x. The proof of the above Lemma 1 is as follows:
Starting from Equation (2), for any
$$f ( x , t ) ∈ H$$
,
$$\begin{matrix}L \left({f}_{0} \left(x , t\right)\right) = {E}_{x , y , t ∼ {D}_{mod \left(t , T\right)} \left(x , y\right) p \left(mod \left(t , T\right)\right)} \left[l \left({f}_{0} \left(x , t\right) , y\right)\right] \\ = {E}_{p \left(mod \left(t , T\right)\right)} \left\{{E}_{x , y , ∼ {D}_{mod \left(t , T\right)} \left(x , y\right)} \left[l \left({f}_{0} \left(x , t\right) , y\right)\right]\right\} , \\ \leq {E}_{p \left(mod \left(t , T\right)\right)} \left\{{E}_{x , y , ∼ {D}_{\text{οκ} \text{id} \left(t , T\right)} \left(x , y\right)} \left[l \left({f}_{0} \left(x , t\right) , y\right)\right]\right\} \\ = L \left(f \left(x , t\right)\right) ,\end{matrix} \qquad \text{(3)}$$
where the inequality follows from the assumption that
$$\begin{matrix}{E}_{x , y , ∼ {D}_{mod \left(t , T\right)} \left(x , y\right)} \left[l \left({f}_{0} \left(x , t\right) , y\right)\right] \leq \\ {E}_{x , y , ∼ {D}_{mod \left(t , T\right)} \left(x , y\right)} \left[l \left(f \left(x , t\right) , y\right)\right]\end{matrix} \qquad \text{(4)}$$
for any
$$f ( x , t ) ∈ H$$
. Hence, ƒ₀(x, t) is a minimizer of Equation (2).

Lemma 1 implies that, if (2) has a unique minimizer, and if

$${f}_{t}^{*} \left(x\right)$$

belongs to the Hilbert Space

$$H$$

when treated as a function of both x and t, then the minimizer of (2) leads to the solution of Equation (1). Hence, under a realizable setting, Equation (2) serves as a proxy to solving Equation (1). According to the above proof, it indicates that, under a realizable setting and a strictly convexity used in the Lemma 1, it is possible to obtain a desired set of solutions for Equation (1) by minimizing a proxy loss specified in Equation (2).

Another critical element in (2) is the design of

$$H$$

. Here, the focus is particularly on functions that are continuous, periodic in time, and have finite energy in a single period. In addition, the functions in

$$H$$

need to degenerate to

$${L}_{2} ( X )$$

as specified in Equation (1) for every fixed t. Two important elements required for designing such an

$$H$$

are introduced.

In addition, defining functions on circles is an important way to characterize periodic functions. As they are defined for points on a circle, these functions take a point’s angular information as their inputs, and therefore naturally have a period that is determined by the circle’s circumference. To facilitate optimization, a Hilbert space structure is further defined over these functions, based on the intuition that views a circle as a line segment with its end-points glued together, as follows:

$$\begin{matrix}{L}_{2} \left({S}^{T}\right) = \\ \left\{f : ℝ \to ℝ : {\int }_{0}^{T} {\left|f \left(t\right)\right|}^{2} \text{dt} < ∞ \text{and} f \left(t + T\right) = f \left(t\right) ∀ t ∈ ℝ\right\} .\end{matrix} \qquad \text{(5)}$$

Equation (5) indicates that the function f is mapped to such a space where the function f has a finite energy, i.e.,

$${\int }_{0}^{T} {\left|f \left(t\right)\right|}^{2} \text{dt} < ∞ ,$$

< and the function f is a periodic function with a periodicity of T, i.e., ƒ(t+ T) = ƒ(t) ∀t ∈ ℝ. As it turns out, if

$$\left〈f , g\right〉 {=}^{\text{def}} {\int }_{0}^{T} f \left(t\right) g \left(t\right) d t ,$$

then

$$\left({L}_{2} \left({S}^{T}\right) , \left〈; .\right〉\right)$$

forms a Hilbert space. This Hilbert space meets the needs in the special case when there is no input feature to the model, i.e., when ƒ(x, t) depends on t only.

To further augment

$${L}_{2} ( {S}^{T} )$$

into a Hilbert space that contains functions dependent on both x and t, the concept of tensor product between Hilbert spaces is needed, which is a direct function space extension to the concept of Kronecker product between vectors in Euclidean spaces.

Specifically, given two Hilbert spaces denoted by

$$\left({H}_{1} , {\left〈; .\right〉}_{1}\right)$$

and

$$\left({H}_{2} , {\left〈; .\right〉}_{2}\right)$$

, respectively, the tensor product of

$${H}_{1}$$

and

$${H}_{2}$$

is a Hilbert space

$$\left(H ≜ {H}_{1} ⊗ {H}_{2} , \left〈⋅ , ⋅\right〉\right)$$

coupled by a bi-linear mapping

$$ϕ : {H}_{1} \times {H}_{2} \to H$$

. Together,

$$H$$

and ϕ satisfy the following properties. (i) The set of vectors ϕ(u₁, u₂) with

$${u}_{1} ∈ {H}_{1}$$

and

$${u}_{2} ∈ {H}_{2}$$

must form a total subset of

$$H$$

. That is,

$$H = \text{Span} \left\{ϕ \left({u}_{1} , {u}_{2}\right) \vert {u}_{1} ∈ {H}_{1} , {u}_{2} ∈ {H}_{2}\right\}$$

. (ii) The inner product of

$$H , \left〈; .\right〉$$

satisfies

$$\left〈ϕ \left({u}_{1} , {u}_{2}\right) , ϕ \left({u}_{1} , {v}_{2}\right)\right〉 = {\left〈{u}_{1} , {v}_{1}\right〉}_{1} {\left〈{u}_{2} , {v}_{2}\right〉}_{2}$$

for any

$${u}_{1} , {v}_{1} ∈ {H}_{1}$$

and

$${u}_{2} , {v}_{2} ∈ {H}_{2}$$

. Adopting two orthonormal sets of basis functions,

$${\left\{{e}_{1 i}\right\}}_{i = 1}^{dim \left({H}_{1}\right)}$$

and

$${\left\{{e}_{2 i}\right\}}_{i = 1}^{dim \left({H}_{2}\right)}$$

for

$${H}_{1}$$

and

$${H}_{2}$$

, respectively, these aforementioned properties would allow us to expand any element

$$ϕ ( {u}_{1} , {u}_{2} ) ∈ H$$

into

$$ϕ \left({u}_{1} , {u}_{2}\right) = {\sum }_{i = 1}^{dim \left({H}_{1}\right)} {\sum }_{j = 1}^{dim \left({H}_{2}\right)} {u}_{1 i} {u}_{2 j} ϕ \left({e}_{1 i} , {e}_{2 j}\right) ,$$

where

$${u}_{1 i} = {\left〈{u}_{1} , {e}_{1 i}\right〉}_{1}$$

and

$${u}_{2 j} = {\left〈{u}_{2} , {e}_{2 j}\right〉}_{2}$$

, respectively. Furthermore, when

$${H}_{1} = {L}_{2} ( X )$$

and

$${H}_{2} ( Y ) = {L}_{2} ( Y )$$

as is the case for the above problem, an isomorphism exists such that

$$ϕ \left({e}_{1 j} , {e}_{2 j}\right) ≅ {e}_{1 i} {e}_{2 j}$$

. This implies that it is possible to consider an isomorphism of

$${H}_{1} ⊗ {H}_{2}$$

containing functions that are linear combinations of

$${\left\{{e}_{1 i} {e}_{2 j}\right\}}_{i = 1 , j = 1 ,}^{∞}$$

i.e.,

$$H = {L}_{2} ( X ) ⊗ {L}_{2} ( Y ) ≅ L ( X \times Y )$$

.

### A Tensor-Product-Based Design of ℋ

To augment

$${L}_{2} ( {S}^{T} )$$

by its tensor product with

$${L}_{2} ( X )$$

, a natural choice of the Hilbert space

$$H$$

is to set

$$H ≜ {L}_{2} \left(X \times {S}^{T}\right) ,$$

where

$$\begin{matrix}{L}_{2} \left(X \times {S}^{T}\right) = \left\{f : X \times ℝ \to ℝ \left|{\left‖f\right‖}_{{L}_{2} \left(X \times \left[0 , T\right]\right)} < ∞\right)\right) \\ \left(\text{and} f \left(x , t\right) = f \left(x , t - T\right) ∀ t\right\} .\end{matrix} \qquad \text{(7)}$$

This

$${L}_{2} ( X \times {S}^{T} )$$

expands

$${L}_{2} ( X )$$

with an additional dimension in t defined on a circle with a circumference T, which naturally restricts

$$f ( x , t ) ∈ H$$

to be a periodic function over the time t for any fixed x ∈ X. The inventors have found the following Lemma 2, which certifies that

$$H$$

is a Hilbert space and characterizes its basis functions using the isomorphism between

$$H$$

and

$${L}_{2} ( X ) ⊗ {L}_{2} ( {S}^{T} )$$

Lemma 2. Let

$$H$$

be defined in Equation (7). For

$$f , g ∈ H$$

, let

$$\left〈f , g\right〉 {=}^{\text{def}} {\int }_{X} {\int }_{0}^{T} f \left(x , t\right) g \left(x , t\right) \text{d} x \text{d} t , \qquad \text{(8)}$$

then

$$\left(H , \left〈; .\right〉\right)$$

is a Hilbert space. Furthermore, there exists an isomorphism between

$$H$$

and

$${L}_{2} ( X ) ⊗ {L}_{2} ( {S}^{T} )$$

, i.e., if

$${\left\{{ϕ}_{i}\right\}}_{i = 1}^{∞}$$

and

$${\left\{{ψ}_{j}\right\}}_{j = 1}^{∞}$$

are two orthonormal sets of basis for

$${L}_{2} ( X )$$

and

$${L}_{2} ( {S}^{T} )$$

, respectively, then

$${\left\{{ϕ}_{i} {ψ}_{j}\right\}}_{i , j = 1}^{∞ .}$$

, where,

$${φ}_{i j} \left(x , t\right) {=}^{\text{def}} {ϕ}_{i} \left(x\right) {ψ}_{j} \left(t\right) ,$$

is an orthonormal set of basis functions for

$$H$$

.

The above lemma paves the way for a theoretically guaranteed algorithm that optimizes

$$L ( f )$$

through a basis expansion of ƒ in

$$H$$

, which will be introduced in the following. In the meantime,

$$H$$

is general enough for the learning purpose in the sense that the function ƒ₀(x, t) defined point-wise by solutions in Equation (1) belongs to

$$H$$

under mild assumptions. Some definitions and assumptions are introduced as below.

Definition 3 (Continuity under total variation). Let Dₜ (x) be the conditional distribution of y given x under Dₜ. Dₜ(x) is considered continuous in t under total variation distance if, for any fixed t and any ∈> 0, there exists δ > 0 such that ||Dₜ′(x) - Dₜ(x)||_{TV} ≤ ∈ wherever |t′ - t| ≤ δ.

Assumption 4. Suppose: (i) X and Y are compact and convex sets; (ii) Dₜ(x) in Definition 3 is continuous under total variation for all x ∈ X ; (iii) the loss function ℓ(ƒ(x), y) is σ-strongly-convex in its first argument for all y ∈ Y; (iv) f(x) in (1) is bounded and max_{x∈}x,_{y}∈y ℓ(f(x), y) ≤ K for some constant K.

Assumption 4 can be easily satisfied by a wide range of machine learning systems. For instance, deep neural networks (DNNs) typically have bounded outputs when a clipping on the final output is enforced. The uniform strong convexity of the loss function also holds for a wide range of ℓ such as the mean square loss. With the above definition and assumption, the inventors have found another Lemma, Lemma 5.

Lemma 5. Under Assumption 4,

$${f}_{t}^{*} \left(x\right)$$

is continuous in t for any given x ∈ X. In addition,

$${f}_{0} \left(x , t\right) {=}^{\text{def}} {f}_{t}^{*} \left(x\right) ∈ H .$$

Lemma 5 implies that, under Assumption 4, the optimal solution of Equation (2), f₀(x, t), belongs to

$$H$$

. Combining Lemmas 1 and 5, it can be seen that the satisfaction of Assumption 4 allows us to acquire a set of desired solution of Equation (1) by solving Equation (2).

### Fourier Learning With Periodic Data

It now proceeds to introduce Fourier learning, a learning framework that hard-wires the periodicity of the data-distribution into the model’s structure via a partial Fourier expansion and learns the model by learning its Fourier coefficient functions. To do so, from a modeling aspect, Lemma 2 is invoked and

$$f ( x , t ) ∈ H$$

may be represented with the following basis expansion:

$$f \left(x , t\right) = {\sum }_{i = 1}^{∞} {\sum }_{j = 1}^{∞} {c}_{i , j} {ϕ}_{i} \left(x\right) {ψ}_{j} \left(t\right) = {\sum }_{j = 1}^{∞} {c}_{j} \left(x\right) {ψ}_{j} \left(t\right) , \qquad \text{(9)}$$

where

$${c}_{j} ( x ) ∈ {L}_{2} ( X )$$

is the sum of

$${C}_{i , j} {ϕ}_{i} ( x )$$

over i. It is noticed that a set of basis functions for

$${L}_{2} ( {S}^{T} )$$

is the trigonometric functions with a base frequency 1/T.a The inventors reach the following Theorem.

Theorem 6. Any function

$$f ( x , t ) ∈ H$$

f(x, t) ∈ ℌ can be represented by a Fourier expansion:

$$f \left(x , t\right) = {\sum }_{n = 0}^{∞} \left[{a}_{n} \left(x\right) sin \left[\frac{2 π n t}{T}\right] + {b}_{n} \left(x\right) cos \left[\frac{2 π n t}{T}\right]\right] , \qquad \text{(10)}$$

where

$${a}_{n} ( x ) , {b}_{n} ( x ) ∈ {L}_{2} ( X )$$

and

$${a}_{0} ( x ) ≡ 0$$

.

Theorem 6 provides an explicit way of designing periodic models and specifies how the time-feature could be exploited. Note that, it is entirely possible to construct

$$H$$

. with a weighted

$${L}_{2}$$

space defined on circles to guarantee periodicity. This allows us to deviate from the trigonometric functions and use potentially other periodic functions to encode periodicity.

With f(x, t) represented by Equation (10), the solution of the problem in Equation (2) is reduced to learn aₙ(x) and bₙ(x), i.e., the Fourier coefficients of ƒ(x, t) that are now independent of t and only dependent on x. In addition, the sine and cosine components are dependent on t. Since Equation (10) takes the form of a partial Fourier expansion of ƒ(x, t), this learning method may be referred to as “Fourier learning”.

Fourier learning allows the designer to retain his original model design, but at the same time mixes the last hidden layer’s expert’s advice in a time-dependent fashion. This explicit role of t in the prediction model circumvents the laborious feature engineering required when the feature t is implicitly added to the model in the form of ƒ(x,t) .

The goal now shifts towards learning the coefficient functions in the frequency domain. For tractable learning, a cutoff frequency N/T may be introduced and thus a truncated Fourier expansion of ƒ(x, t) may instead be represented as follows:

$${f}_{N} \left(x , t\right) = {\sum }_{n = 0}^{∞} \left[{a}_{n} \left(x\right) sin \left[\frac{2 π n t}{T}\right] + {b}_{n} \left(x\right) cos \left[\frac{2 π n t}{T}\right]\right] , \qquad \text{(11)}$$

where N is a predetermined number, which is an integer larger than one.

The truncated Fourier expansion in Equation (11) is an approximation to the Fourier expansion in Equation (10). The approximation error for all

$$f ∈ H$$

in Equation (11) may be denoted as E_{N}(ƒ), which may be determined as follows:

$${E}_{N} \left(f\right) = {\left‖f \left(x , t\right) - {f}_{N} \left(x , t\right)\right‖}_{H}^{2} . \qquad \text{(12)}$$

In practical systems, it can be commonly assumed that lim_{N→∞} E_{N}(ƒ) = 0 for all

$$f ∈ H$$

. Hence, with a properly selected N, the approximation error may be limited as well as the amount of model parameters.

In the Fourier expansion for Fourier learning in Equation (11), Fourier coefficients aₙ(x) and bₙ(x) are needed to be determined so as to generate a prediction result of the model ƒ(x,t). The Fourier coefficients aₙ(x) and bₙ (x) may be considered as coefficient functions dependent on x, which can be learned under a variety of regimes. For example, they can be learned non-parametrically using function optimization algorithms.

In some embodiments, if the Fourier coefficients aₙ(x) and bₙ(x) have a parametric form, such as a neural network, stochastic gradient descent is known to converge to stationary point at a certain rate under standard assumptions, which may be introduced in detail below. In some embodiments, apart from the above parametric framework, Fourier learning also fits into the non-parametric regime, which may be introduced in detail below.

### Machine Learning System Based on Fourier Learning

In the following, it is discussed parameterizing of aₙ(x) and bₙ(x) with neural networks, so as to apply Fourier learning to large-scale machine learning scenarios.

The above theory analysis indicates that a model constructed based on a Fourier learning can intuitively exploit the periodicity of training data and can be expressed as a periodic function with the periodicity. Thus, the Fourier learning can be adapted to a machine learning-based prediction model. In embodiments of the present disclosure, according to the Fourier expansion of ƒ(x,t) in Equation (11), it is proposed to view x as information related to an input data sample generated at a certain point of time t. The input data sample may be of a data sample of periodic data. A Fourier expansion result can be determined based on the Fourier expansion and a prediction result for the input data sample is then determined based on the Fourier expansion result.

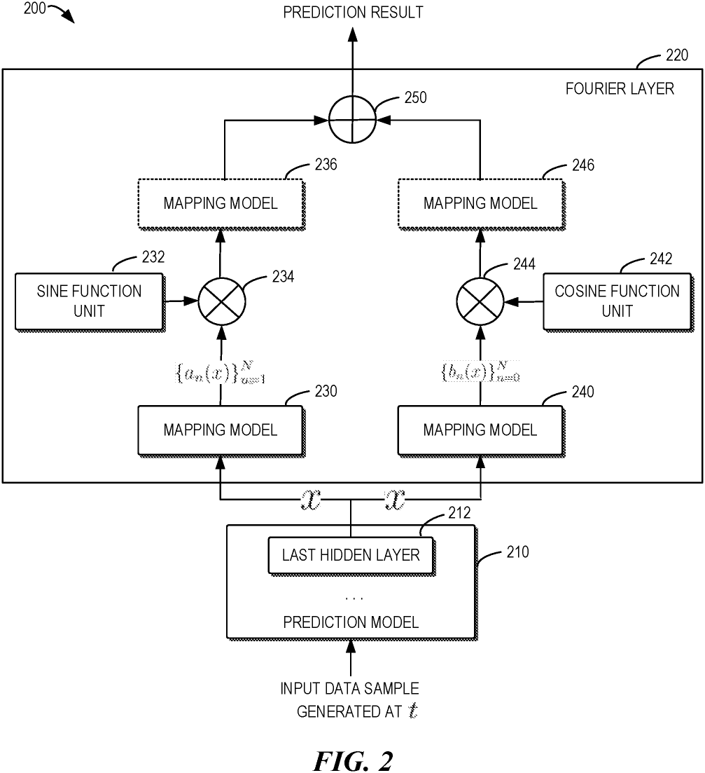

Reference is now made to FIG. 2, which illustrates a block diagram of a machine learning system 200 with Fourier learning in accordance with some example embodiments of the present disclosure. The machine learning system 200 may be implemented as the machine learning model 105 in the environment 100. As illustrated, the machine learning system 200 comprises a prediction model 210 and a Fourier layer 220.

The prediction model 210 may be configured with any model architectures to implement a prediction task. In embodiments of the present disclosure, input data to be processed by the prediction model 210 are periodic data with a certain periodicity (represented as T). The input to the prediction model 210 is an input data sample generated at a certain point of time t. The Fourier layer 220 is introduced to allow generating more accurate prediction results by considering the periodicity within the input data. It is noted that the prediction model 210 may be constructed in any manner which may or may not exploit the periodicity of the input data because in either case, the addition of the Fourier layer 220 can further exploit the periodicity.

The Fourier layer 220 is designed by the following intuition: if x is considered as the output of an original prediction model’s last hidden layer, then Equation (11) can be viewed as the network’s output layer with an architecture shown in FIG. 2. Specifically, the Fourier layer 220 first transforms x into aₙ(x) and bₙ(x), and then element-wise multiplies them with basis vectors SIN and COS, yielding a (2N + 1)-dimension result. This result may be then added up, yielding a scalar output. Notably, when aₙ(x) = bₙ(x) =0 for all n ≥ 1, the final output equals b₀(x), which, by itself, can be interpreted as the original model’s output. This implies that replacing the original model’s output layer with the Fourier layer 220 increases its capacity, avoiding the need for laborious feature engineering.

In particular, the Fourier layer 220 receives a feature representation of the input data sample extracted by the prediction model 210. The prediction model 210 may generally be considered as consisting of two parts, one is to extract hidden features within the input data sample and the other one is to determine a model output based on the final hidden feature. In some embodiments, the prediction model 210 may comprise a plurality of layers, including an input layer to receive the input data sample, one or more hidden layers to process the input data sample and generate a feature representation to characterize hidden features within the input data sample, and an output layer to generate the model output. The layers of the prediction model 210 are connected layer-by-layer and an output from a layer being provided to a next layer as an input.

In some embodiments, the feature representation extracted at a last hidden layer 212 of the prediction model 210 is provided to the Fourier layer 220 as its input. This feature representation is represented as x. Typically, the input data sample may comprise redundant information and may be of a higher dimension. Through the feature extraction in the prediction model, the feature representation may be able to characterize useful feature information within the input data sample with a relatively small dimension. The Fourier layer 220 may be able to further process the feature representation x to generate a prediction result for the input data sample.

It is assumed that the feature representation x is of a dimension d₁, and the prediction result for the input data sample is of a dimension d₂. The dimension of the feature representation x and the dimension of the prediction result (d₂) may depend on the configuration of the prediction model 210. Generally, d₁ is larger than one, and d₂ may be equal to or larger than one. For example, the prediction result may be a single-dimensional output to indicate, for example, a probability of a user being interest of a target item, or may be a multi-dimensional output to indicate, for example, respective probabilities of a user being interest of a plurality of items.

Given the input (i.e., the feature representation x) and the output (i.e., the prediction result) of the Fourier layer 220, the processing of the Fourier layer 220 may be considered as mapping the input with a dimension of d₁ to the output with a dimension of d₂. The model structure of the Fourier layer 220 may be designed to implement such mapping based on the Fourier expansion.

As illustrated, the Fourier layer 220 comprises a mapping model 230 to generate Fourier coefficients aₙ(x) in a Fourier expansion, and a mapping model 240 to generate Fourier coefficients bₙ(x) in the Fourier expansion. Following the truncated Fourier expansion in Equation (11) which has a predetermined number (N+1) of terms, the mapping model 230 may be configured to transform the feature representation x with the dimension d₁ into an output with a dimension N, and the mapping model 240 may be configured to transform the feature representation x with the dimension d₁ into an output with a dimension of (N+1). The N elements in the output of the mapping model 230 may be determined as N Fourier coefficients

$${\left\{{a}_{n} \left(x\right)\right\}}_{n = 1}^{N} .$$

The (N+1) elements in the output of the mapping model 240 may be determined as (N+1) Fourier coefficients

$${\left\{{b}_{n} ( x )\right\}}_{n = 0}^{N}$$

.

The mapping model 230 and the mapping model 240 may be constructed based on any machine learning architecture. In some embodiments, the mapping model 230 and the mapping model 240 may be constructed without activation functions. Generally, an activation function applied in a machine learning model (e.g., sigmoid function, tanh function, ReLU function) may restrict the amplitude of the model output into a certain range. In the Fourier expansion, since there is no explicit restriction on the amplitude of the Fourier coefficients, the mapping model 230 and the mapping model 240 may configured with no activations.

A Fourier expansion generally comprises a sine function-based component and a cosine function-based component. Accordingly, as illustrated in FIG. 2, the Fourier layer 220 further comprises a sine function unit 232 to determine values for the sine component in the Fourier expansion, and a cosine function unit 242 to determine values for the cosine component in the Fourier expansion. As shown in Equation (11), the sine component is based on a sine function dependent on the point of time t which is a periodic function with the periodicity of T, and the cosine component is based on a cosine function dependent on the point of time t which is a periodic function with the periodicity of T.

The sine function unit 232 may provide a set of sine component values as a column vector [sin(2πt/T), ..., sin(2πNt/T)]^{T}, and the cosine function unit 242 may provide a set of cosine component values as a column vector [1, cos(2πt/T), ..., cos(2πNt/T)]^{T}. In some embodiments, the time is variable with t ∈ [0,T]. That is, the actual point of time when the input data sample is generated is transformed to a point within a period of T, for example, through the mod operation.

The N sine component values [sin(2πt/T), ..., sin(2πNt/T)]^{T} may be generated by shifting a frequency of the sine function for N times, and the (N+1) cosine component values [1, cos(2πt/T), ..., cos(2πNt/T)]^{T} may be generated by shifting a frequency of the sine function for (N+1) times. Starting from a phase of zero, for each time of phase shifting, a phase shift of 2πt/T is applied to the sine function and the cosine functions. It is noted that the sine function and the cosine function may be phase-shifted for a same number of (N+1) times, but at the initial time the sine component value at the zero phrase is zero.

At the Fourier layer 220, the Fourier coefficients

$${\left\{{a}_{n} \left(x\right)\right\}}_{n = 1}^{N}$$

and

$${\left\{{b}_{n} \left(x\right)\right\}}_{n = 0}^{N}$$

are determined in real time in response to the input data sample generated at each point of time. In some embodiments, the sine and cosine component values [sin(2πt/T), ..., sin(2πNt/T)] and 1,cos(2πt/T), ..., cos(2πNt/T) may be pre-calculated and stored in memory for use.

The N sine component values and the N Fourier coefficients are provided to a multiplier 234. The multiplier 234 is configured to perform element-wise multiplication on the N sine component values and the N Fourier coefficients to generate N products. The (N+1) cosine component values and the (N+1) Fourier coefficients are provided to a multiplier 244. The multiplier 244 is configured to perform element-wise multiplication on the (N+1) cosine component values and the (N+1) Fourier coefficients to generate (N+1) products. The (2N+1) products are corresponding to the individual terms involved in the Fourier expansion.

In order to obtain a prediction result with the dimension of d₂, the N products from the multiplier 234 may be input into a mapping model 236, and the (N+1) products from the multiplier 244 may be input into a mapping model 246. The mapping model 236 may be configured to transform the N products from the multiplier 234 into a first intermediate expansion result with a dimension of d₂, and the mapping model 246 may be configured to transform the (N+1) products from the multiplier 244 into a second intermediate expansion result with a dimension of d₂. The first and second intermediate expansion results may be provided to an aggregator 250, which is configured to perform an element-wise summation on the first and second intermediate expansion results to provide a Fourier expansion result, which may be determined as a prediction result for the input data sample with a dimension of d₂.

In some embodiments, if the prediction result is a single-dimensional output, the mapping models 236 and 246 may be omitted from the Fourier layer 220. In this case, the products from the multiplier 234 and 244 are summed up to provide a Fourier expansion result, which may be determined as the prediction result.

In some embodiments, the mapping model 230 and the mapping model 240 may be constructed as multi-layer perceptron (MLP) models. In some embodiments, the mapping model 236 and the mapping model 246 may be constructed as MLP models. The Fourier layer 220 may thus be considered as a Fourier-MLP (F-MLP) layer.

The parameter values of the mapping models 220, 240, 236, and 246 in the Fourier layer 220 may be determined through a training process. In some embodiments, these mapping models may be trained with the prediction model 210. The training data may include input data samples to the prediction model 210 and labeling information indicating corresponding groundtruth labels for the input data samples. In some embodiments, the mapping models in the Fourier layers may be trained in an end-to-end manner with the prediction model 210. In some embodiments, the prediction model 210 may be first trained and then retrained together with the mapping models in the Fourier layers.

In some embodiments, the Fourier layer 220 may be generalized as

$${\text{F-MLP}}_{{d}_{1} \to {d}_{2}}^{\left[N\right]} \left(x\right) ∈ {ℝ}^{{d}_{2} \times 1} ,$$

for an F-MLP with input dimension d₁ and output dimension d₂, its processing may be represented follows:

$$\begin{matrix}{\text{F-MLP}}_{{d}_{1} \to {d}_{2}}^{\left[N\right]} \left(x\right) = \\ \left({W}_{2} ⊙ \text{COS}\right) ⋅ {\text{MLP}}_{d 1 \to \left(N + 1\right)} \left(x\right) + \left({W}_{1} ⊙ \text{SIN}\right) ⋅ {\text{MLP}}_{{d}_{1} \to N} \left(x\right) ,\end{matrix} \qquad \text{(13)}$$

where x ∈ ℝ^{d1}^{×} ¹ is the input to the Fourier layer 220, MLP_{d}_{1→N}(x) ∈ ℝ^{N} ^{×} ¹ is a regular MLP that maps x into a vector of dimension N, having no activations; W₁ ∈ ℝ^{d}² ^{×} ^{N} and W₂ ∈ ℝ^{d}² ^{× (}^{N+1)} are the parameter values; while SIN and COS are matrices stacked up by row vectors [sin(2πt/T), ..., sin(2πNt/T)] and [1, cos(2πt/T), ..., cos(2πNt/T)] a total of d₂ times. The operator ⊙ is the Hadamard product. When d₂=1 (which means that the output is one-dimentional), W₁ and W₂ can be merged into MLP_{d}₂_{→N} and MLP_{d}₁ _{→(N+1)}, which serve the role of aₙ(x) and bₙ(x) in Equation (11), respectively.

It is noted that there are some approaches that propose to combine Fourier analysis with deep learning systems. However, most of those approaches are aimed at learning the intrinsic high-frequency component within the distribution of the input data itself, rather than focusing on the periodicity of the distribution in time. In particular, the inventors have observed that the implementation of the Fourier layer of the present disclosure into existing designs of prediction model fundamentally alters the physical meaning of each processing unit in the model: under a regular model, each processing unit is an expert that changes its decisions through time; under the Fourier layer of the present disclosure, each processing unit holds the frequency component of an expert that decides how drastically he alters his decisions through time at a given frequency. The former requires designing an online-learning algorithm to track a constantly varying optimal for each expert, while for the latter the future optimal can be predicted using the interpolation with the trigonometric functions. This offers advantage over the online learning approach.

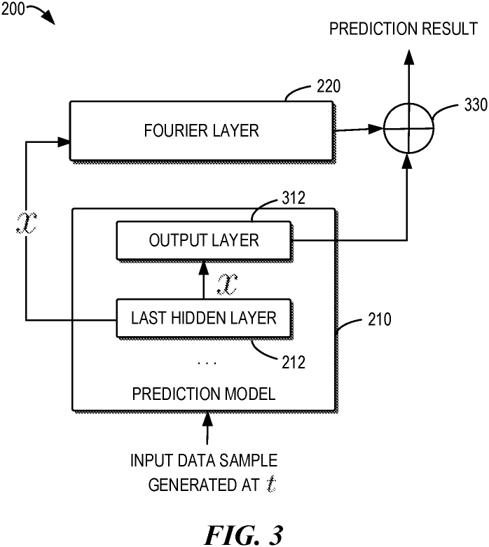

In the example embodiments of FIG. 2, the Fourier layer 220 is introduced as an output layer for the prediction model 210, and thus its output is determined as the prediction result for the input data sample. In some embodiments, the Fourier layer 220 may operate with a complete prediction model 210 (comprising its own output layer), and the output from the Fourier layer 220 and the output from the prediction model 210 are aggregated to generate a final prediction result. FIG. 3 illustrates the machine learning system 200 in accordance with such embodiments.

As illustrated in FIG. 3, the prediction model 210 comprises, among other layers, an output layer 312 which receives the feature representation x from the last hidden layer 212. The output layer 312 in the prediction model 210 may process the feature representation x and generate an intermediate prediction result. The processing in the output layer 312 may depend on the configuration of the prediction model 210, which may be varied in different prediction tasks. The Fourier layer 220 may also receive the feature representation x from the last hidden layer 212 and generate an intermediate prediction result based on a Fourier expansion result, as discussed according to the embodiments with respect to FIG. 2.

The machine learning system 200 may further comprise an aggregator 330 which is configured to mix the two intermediate prediction results from the prediction model 210 and the Fourier layer 220. For example, the aggregator 330 may determine a weighted-sum of the two intermediate prediction results. The aggregation of the intermediate prediction results may be represented as follows:

$$f \left(x , t\right) = λ {f}_{\text{oco}} \left(x , t\right) + \left(1 - λ\right) {f}_{\text{fl}} \left(x , t\right) \qquad \text{(14)}$$

where ƒ(x,t) represents the prediction result for the input data sample; ƒ_{oco}(x,t) represents the intermediate prediction result by the output layer 312 of the prediction model 210; and ƒ_{ß}(x,t) represents the intermediate prediction result generated by the Fourier layer 220; λ is a parameter used to weight the two intermediate prediction results. λ may be of a predetermined value, e.g., 0.5 or any other value.

In some embodiments, the prediction model 210 may has a complicated structure, for example, may comprise a plurality of sub-models having different model structures. In this case, the input to the Fourier layer 220 may be carefully designed. FIG. 3 illustrates the machine learning system 200 in accordance with such embodiments.

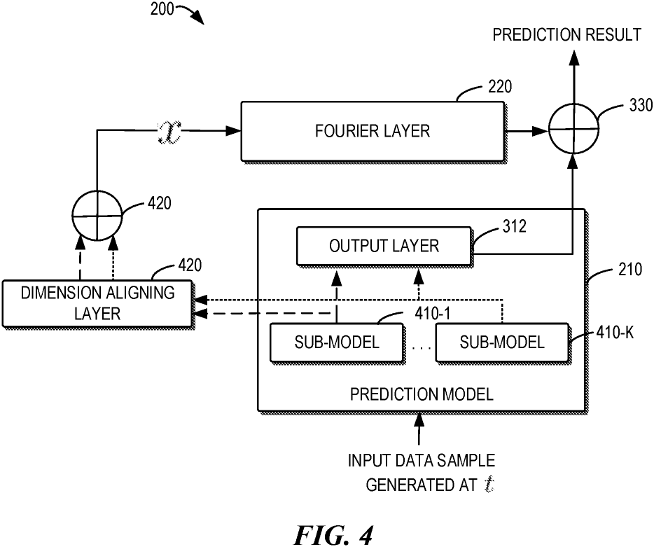

As illustrated in FIG. 4, the prediction model 210 may comprise a plurality of sub-models (e.g., K sub-models), such as a sub-model 410-1, ..., a sub-model 410-K (collectively or individually referred to as sub-models 410 for the purpose of discussion). K is an integer larger than one. The outputs of the sub-models may be added up at the output layer 312 in the prediction model 210 to provide an output of the model. In this case, the output layer 312 may comprise an aggregator to perform a summation on the respective outputs from the K sub-models 410. The prediction model 210 may thus be represented as

$${f}_{\text{oco}} \left(x , t\right) = {\sum }_{m = 1}^{K} {f}_{m} \left(x , t\right) ,$$

where ƒₘ(x,t) represents the output of the m-th sub-model 410.

With the structure of the prediction model 210 illustrated in FIG. 4, a sub-model 410 may extract a feature representation from the input data sample at its last hidden layer and determine its own output at its output layer based on the feature representation. The feature representations from the sub-models 410 may be aggregated to generate the feature representation x to be input into the Fourier layer 220. In some embodiments, the feature representations from the sub-models 410 may be of different dimensions. In the embodiments of FIG. 4, to aggregate the feature representations from the sub-models 410, the machine learning model 200 may further comprise a dimension aligning layer 420, to transform respective feature representations with different dimensions from the sub-models 410 into feature representations with the same dimension. In some embodiments, the dimension aligning layer 420 may comprise a plurality of MLPs, each configured to transform the feature representation from one of the sub-models 410 to a feature representation with the same dimension.

Since the Fourier layer 220 performs liner transform on its input, the feature representations with the same dimension generated from the dimension aligning layer 420 may be added together to obtain the feature representation x to input into the Fourier layer 220. In this case, the dimension aligning layer 420 may transform the feature representations with different dimensions from the sub-models 410 into feature representations with the dimension of d₁.

In FIG. 4, it is illustrated that the output from the Fourier layer 220 is aggregated with the output from the prediction model 210 by the aggregator 330 as in FIG. 3. It would be appreciated that in other embodiments, the processing on the feature representations may be integrated into the system 200 illustrated in FIG. 2.

### Training of Machine Learning System

The training of the Fourier layer 220 is performed jointly with the prediction model, following the procedure of streaming-SGD. This procedure is different from the standard SGD, which in practice would need sample data (x,y,t) ~ Dₜ(x,y)p(t). However, sampling from p(t) is difficult for many online applications due to the real-time update requirement, where data arrives sequentially. Here we show that using streaming-SGD can avoid this issue while still having good practical performances and convergence guarantees.

The training procedure is as follows. aₙ(x) and bₙ(x) may be parameterized by aₙ(x;θₙ) and bₙ(x;ρₙ), respectively, with θₙ and ρₙ being the neural network parameters. For cyclical data, the τ-th mini-batch of data may be collected in the k-th cycle, and the model may be updated with the following update rule:

$$\begin{matrix}{θ}_{n}^{\left(k , τ + 1\right)} = {θ}_{n}^{\left(k , τ\right)} - {η}_{k , τ ,} {g}_{{θ}_{n}}^{\left(k , τ\right)} , \\ {ρ}_{n}^{\left(k , τ + 1\right)} = {ρ}_{n}^{\left(k , τ\right)} - {η}_{k , τ} {g}_{{ρ}_{n}}^{\left(k , τ\right)} .\end{matrix} \qquad \text{(15)}$$

Here,

$${g}_{{θ}_{n}}^{\left(k , τ\right)}$$

and

$${g}_{{ρ}_{n}}^{\left(k , τ\right)}$$

are gradients calculated using the collected mini-batch of data:

$$\begin{matrix}{g}_{{θ}_{m}}^{\left(k , τ\right)} = {∇}_{{θ}_{n}} {\hat{L}}_{k , τ} \left({f}_{N}^{\left(k , τ\right)}\right) , \\ {g}_{{ρ}_{n}}^{\left(k , τ\right)} = {∇}_{{ρ}_{n}} {\hat{L}}_{k , τ} \left({f}_{N}^{\left(k , τ\right)}\right) ,\end{matrix} , \qquad \text{(16)}$$

where

$${f}_{N}^{\left(k , τ\right)}$$

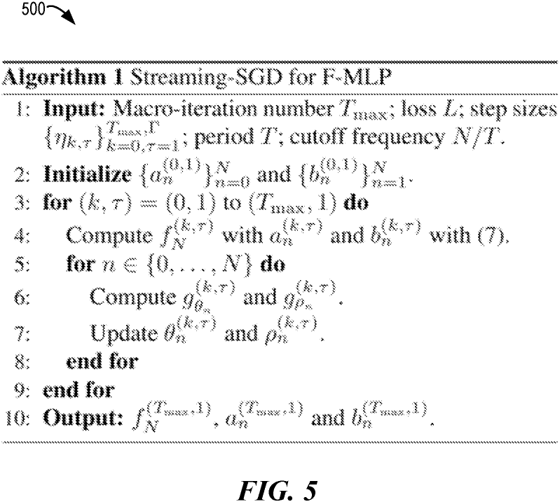

is computed with Equation (11), while L_{k,τ} is the empirical version of the loss in Equation (2) over this mini-batch of data. The overall training procedure is summarized in Algorithm 500 as illustrated in FIG. 5. The convergence analysis of it is presented as below.

The convergence properties are discussed when training the machine learning system based on Fourier learning with streaming-SGD. Recall that, using a truncated ƒ_{N}(x,t), the problem in Equation (2) reduces into finding the optimal of

$${min}_{{\left\{{α}_{n}\right\}}_{n = 1}^{N} , {\left\{{b}_{n}\right\}}_{n = 0}^{N}} {E}_{x , y , t ∼ {D}_{t} \left(x , y\right) p \left(t\right)} \left[l \left({f}_{N} \left(x , t\right) , y\right)\right] \qquad \text{(17)}$$

in frequency domain. The optimal set of coefficient functions of Equation (11) is denoted as

$${a}_{n}^{∗} \left(x\right)$$

and

$${b}_{n}^{∗} \left(x\right) ,$$

for which the corresponding model

$${f}_{N}^{∗} \left(x , t\right)$$

can be expressed as

$${f}_{N}^{∗} \left(x , t\right) = {\sum }_{n = 0}^{N} \left[{a}_{n}^{∗} \left(x\right) sin \left[\frac{2 π n t}{T}\right] + {b}_{n}^{∗} \left(x\right) cos \left[\frac{2 π n t}{T}\right]\right] . \qquad \text{(18)}$$

In the following, it is first shown a gradient norm convergence result for streaming-SGD under a general non-convex setting, and then introduce a global convergence result under the assumption of strong convexity. Prior to that, some additional assumptions are introduced.

Assumption 7. Suppose: (i) for all n, k, τ, the second moment of the update directions are bounded:

$$max \left\{E \left[\left‖{g}_{{ρ}_{n}}^{\left(k , τ\right)}\right‖ {2}_{2} \left|{F}^{\left(k\right)}\right| , E \left[\left‖{g}_{{θ}_{n}}^{\left(k , τ\right)}\right‖ {2}_{2}\right] F \left(k\right)\right]\right\} \leq {G}^{2}$$

for some G ∈ ℝ, where F⁽^{k)} is the minimum σ-algebra generated by

$${a}_{n}^{\left(κ , τ\right)}$$

and

$${b}_{n}^{\left(κ , τ\right)}$$

for all n, κ < k and 1 < τ < Γ. In addition, it is assumed there exists Λ > 0 such that ∥∇L(ƒ₁) - ∇L(ƒ₂)∥ ≤ Λ∥ƒ₁ - ƒ₂∥ for all ƒ₁, ƒ₂ ∈ H.

Assumption 7 assumes bounded second moment of the update directions, and the Lipschitzness of the gradient, which are usually required in the convergence analysis of SGD-type algorithms. The following result shows that streaming-SGD with a proper learning rate achieves convergence under both non-convex and strongly convex settings.

Theorem 8 (Convergence of Streaming-SGD). Let (i), (ii) of Assumption 4 and Assumption 7 hold, and define

$$\left‖∇ L \left({f}_{N}^{\left(k , 1\right)}\right)\right‖$$

as the gradient with respect to a joint parameter vector combining all

$${θ}_{n}^{\left(k , 1\right)}$$

and

$${ρ}_{n}^{\left(k , 1\right)} .$$

Let
$${η}_{k , τ} ≜ {η}_{k} = Θ \left(1 / \sqrt{{T}_{max} + 1}\right) ,$$
then
$${min}_{0 \leq k \leq {T}_{max}} {\left‖∇ L \left({f}_{N}^{\left(k , 1\right)}\right)\right‖}^{2} = O \left(1 / \sqrt{{T}_{max} + 1}\right) .$$
Let
$${η}_{k , τ} ≜ {η}_{k} Θ \left(1 / \sqrt{k}\right) ,$$
then
$${min}_{0 \leq k \leq {T}_{max}} {\left‖∇ L \left({f}_{N}^{\left(k , 1\right)}\right)\right‖}^{2} = O \left(\frac{log \left({T}_{max} + 1\right)}{\sqrt{{T}_{max} + 1}}\right) .$$
Moreover, if L is σ-strongly convex with respect to θₙ and ρₙ, we can take η_{k,τ} = ψ/k with ψ < (2σ²)⁻¹ and obtain
$$E \left‖{θ}_{n}^{\left({T}_{max} , 1\right)} - {θ}_{n}^{∗}\right‖ {2}_{2} = O \left({T}_{max}^{- 1}\right) ,$$
$$E \left‖{ρ}_{n}^{\left({T}_{max} , 1\right)} - {ρ}_{n}^{∗}\right‖ {2}_{2} = O \left({T}_{max}^{- 1}\right) ,$$
where it is assumed
$${a}_{n} \left(x , {θ}_{n}^{∗}\right) = {a}_{n}^{∗} \left(x\right) , {b}_{n} \left(x , {ρ}_{n}^{∗}\right) = {b}_{n}^{∗} \left(x\right) .$$

Simply put, the learning framework offers a convergence rate of

$$O \left(1 / \sqrt{{T}_{max}}\right)$$

under a general non-convex setting and O(1/Tₘₐₓ) under a strongly convex setting. If N → ∞ is further derived, the overall learning error of ƒ₀(x,t) can be driven to arbitrarily small. Compared to the online learning benchmark whose dynamic regret is affected by both the changing speed of the data-generating distribution and the variance of the stochastic gradients, Fourier learning yield a much smaller learning error and hence offers a potentially much better performance in many practical scenarios.

Apart from the above parametric framework, as mentioned above, in some embodiments, the proposed Fourier learning also fits into the non-parametric regime, where aₙ and bₙ are updated directly:

$$\begin{matrix}{a}_{n}^{\left(k , τ + 1\right)} \left(x\right) = {a}_{n}^{\left(k , τ\right)} \left(x\right) - {η}_{k , τ} ⋅ {g}_{{a}_{n}}^{\left(k , τ\right)} \left(x\right) , \\ {b}_{n}^{\left(k , τ + 1\right)} \left(x\right) = {b}_{n}^{\left(k , τ\right)} \left(x\right) - {η}_{k , τ} ⋅ {g}_{{b}_{n}}^{\left(k , τ\right)} \left(x\right) .\end{matrix} \qquad \text{(19)}$$

As the functional gradients in L₂ often contain Dirac’s δ-functions, causing discontinuous updates, we substitute the functional gradients with their kernel embeddings instead. Specifically, with K(·,·) : χ × χ → ℝ being a positive definite kernel whose minimum eigen-value is bounded away from 0, let

$$\begin{matrix}{g}_{{a}_{n}}^{\left(k , τ\right)} \left(x\right) = \left〈\left({∇}_{{a}_{n}} {\hat{L}}_{{k}_{τ}} \left({f}_{N}^{\left(k , τ\right)}\right)\right] \left(⋅\right) , K \left(x , ⋅\right)\right〉 , \\ {g}_{{b}_{n}}^{\left(k , τ\right)} \left(x\right) = \left〈\left({∇}_{{b}_{n}} {\hat{L}}_{{k}_{τ}} \left({f}_{N}^{\left(k , τ\right)}\right)\right] \left(⋅\right) , K \left(x , ⋅\right)\right〉 .\end{matrix} \qquad \text{(20)}$$

It is easy to verify that these kernel embeddings yield continuous updates of aₙ(x) and bₙ(x) at each iteration. At the same time,

$${g}_{{a}_{n}}^{\left(k , τ\right)}$$

and

$${g}_{{b}_{n}}^{\left(k , τ\right)}$$

are “close enough” to the exact gradients and retain the convergence guarantees (Yang et al., 2019). If we initialize

$${a}_{n}^{\left(0 , τ\right)}$$

and

$${b}_{n}^{\left(0 , τ\right)}$$

to be zeros, then

$${a}_{n}^{\left(k , τ\right)}$$

and

$${b}_{n}^{\left(k , τ\right)}$$

can be written as a linear combination of a finite set of kernels. The convergence result for the non-parametric case is given in Theorem 9 below.

Theorem 9. Let Assumption 4 and Assumption 7 hold. Let

$${g}_{{a}_{n}}^{\left(k , τ\right)}$$

and

$${g}_{{b}_{n}}^{\left(k , τ\right)}$$

be the kernel embeddings of functional gradient with K(·,·) at iteration (k, τ), as defined in Equation (20). Let η_{k,τ} = σ(k + 0.5)λ⁻¹(k + 1)⁻². Then,

$$E \left‖{a}_{n}^{\left({T}_{max} , 1\right)}\right) - {a}_{n}^{*} \left‖{}_{2}^{2}\right) = O \left({T}_{max}^{- 1}\right) a n d E \left‖{b}_{n}^{\left({T}_{max} , 1\right)}\right) - {b}_{n}^{*} \left‖{}_{2}^{2} \text{=}\right) O \left({T}_{max}^{- 1}\right) ,$$

with

$${a}_{n}^{∗}$$

and

$${b}_{n}^{∗}$$

defined in Equation (18).

### Example Process

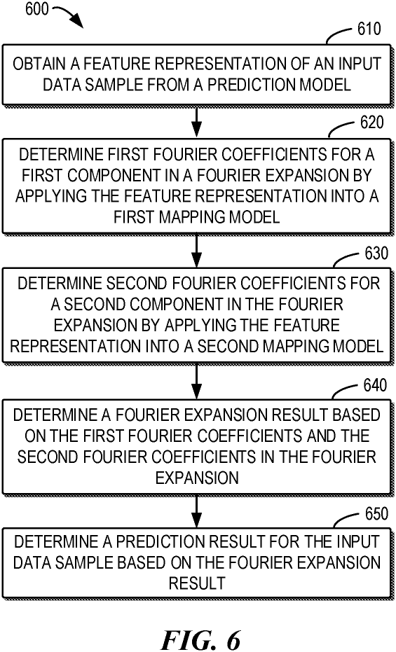

FIG. 6 illustrates a flowchart of a process 600 for Fourier learning in accordance with some example embodiments of the present disclosure. The process 600 may be implemented at the machine learning system 200, or may be implemented by the model application system 120 which can apply input data to the machine learning system 200 to perform the corresponding prediction tasks. For the purpose of discussion, reference is made to FIG. 1 to discuss the process 600.

At block 610, the model application system 120 obtains a feature representation of an input data sample from a prediction model. The prediction model is configured to process input data with a periodicity. The input data sample is a sample of the input data generated at a point of time within a period.

At block 620, the model application system 120 determines first Fourier coefficients for a first component in a Fourier expansion by applying the feature representation into the first mapping model. The Fourier expansion is of the periodicity and dependent on the point of time and the feature representation. At block 620, the model application system 120 determines second Fourier coefficients for a second component in the Fourier expansion by applying the feature representation into a second mapping model.

At block 640, the model application system 120 determines a Fourier expansion result based on the first Fourier coefficients and the second Fourier coefficients in the Fourier expansion. At block 650, the model application system 120 determines a prediction result for the input data sample based on the Fourier expansion result.

In some embodiments, the Fourier expansion comprises a truncated Fourier expansion with a predetermined number of terms, and the number of the first Fourier coefficients and the number of the second Fourier coefficients are based on the predetermined number.

In some embodiments, the first component is based on a sine function dependent on the point of time and having the periodicity, and the second component is based on a cosine function with the periodicity.

In some embodiments, to determine the Fourier expansion result, the model application system 120 determines a set of first component values for the first component by shifting a frequency of the sine function for the predetermined number of times, and determines a set of second component values for the second component by shifting a frequency of the cosine function for the predetermined number of times. The model application system 120 determines the Fourier expansion result by multiplying the first Fourier coefficients with the first component values, respectively, and multiplying the second Fourier coefficients with the second component values.

In some embodiments, to determine the Fourier expansion result, the model application system 120 calculates first products by multiplying the first Fourier coefficients with the first component values and calculates second products by multiplying the second Fourier coefficients with the second component values. The model application system 120 maps the first products to a first intermediate expansion result using a third mapping model, and maps the second products to a second intermediate expansion result using a fourth mapping model. The model application system 120 determines the Fourier expansion result by aggregating the first intermediate expansion result and the second intermediate expansion result.

In some embodiments, to determine the prediction result, the model application system 120 determines a first intermediate prediction result from the Fourier expansion result, and obtains a second intermediate prediction result generated from an output layer of the prediction model based on the feature representation. The model application system 120 determines the prediction result by aggregating the first intermediate prediction result and the second intermediate prediction result.

In some embodiments, the prediction model comprises a plurality of sub-models configured to extract a plurality of feature representations from the input data sample. In some embodiments, the model application system 120 obtains the plurality of feature representations from the plurality of sub-models, and generates the feature representation by aggregating the plurality of feature representations.

In some embodiments, the first mapping model and the second mapping model are constructed without activation functions. In some embodiments, the third mapping model and the fourth mapping model are constructed without activation functions. In some embodiments, the mapping models are trained jointly with the prediction model.

### Example System/Device

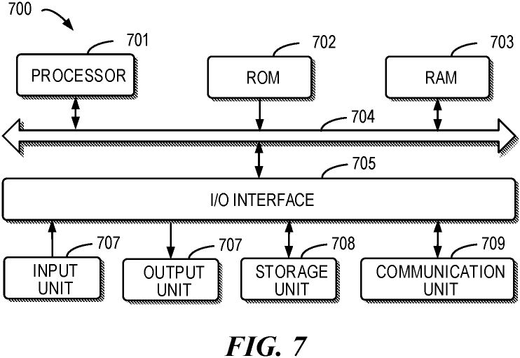

FIG. 7 illustrates a block diagram of an example computing system/device 700 suitable for implementing example embodiments of the present disclosure. The model application system 120 and/or the model training system 110 may be implemented as or included in the system/device 700. The system/device 700 may be a general-purpose computer or computer system, a physical computing system/device, or a portable electronic device, or may be practiced in distributed cloud computing environments where tasks are performed by remote processing devices that are linked through a communication network. The system/device 700 can be used to implement the process 600 of FIG. 6.

As depicted, the system/device 700 includes a processor 701 which is capable of performing various processes according to a program stored in a read only memory (ROM) 702 or a program loaded from a storage unit 708 to a random access memory (RAM) 703. In the RAM 703, data required when the processor 701 performs the various processes or the like is also stored as required. The processor 701, the ROM 702 and the RAM 703 are connected to one another via a bus 704. An input/output (I/O) interface 705 is also connected to the bus 704.

The processor 701 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 700 may have multiple processors, such as an application-specific integrated circuit chip that is slaved in time to a clock which synchronizes the main processor.

A plurality of components in the system/device 700 are connected to the I/O interface 705, including an input unit 707, such as a keyboard, a mouse, or the like; an output unit 707 including a display such as a cathode ray tube (CRT), a liquid crystal display (LCD), or the like, and a loudspeaker or the like; the storage unit 708, such as disk and optical disk, and the like; and a communication unit 709, such as a network card, a modem, a wireless transceiver, or the like. The communication unit 709 allows the system/device 700 to exchange information/data with other devices via a communication network, such as the Internet, various telecommunication networks, and/or the like.

The methods and processes described above, such as the process 600, can also be performed by the processor 701. In some embodiments, the process 600 can be implemented as a computer software program or a computer program product tangibly included in the computer readable medium, e.g., storage unit 708. In some embodiments, the computer program can be partially or fully loaded and/or embodied to the system/device 700 via ROM 702 and/or communication unit 709. The computer program includes computer executable instructions that are executed by the associated processor 701. When the computer program is loaded to RAM 703 and executed by the processor 701, one or more acts of the process 600 described above can be implemented. Alternatively, processor 701 can be configured via any other suitable manners (e.g., by means of firmware) to execute the process 600 in other embodiments.

In some example embodiments of the present disclosure, there is provided a computer program product comprising instructions which, when executed by a processor of an apparatus, cause the apparatus to perform steps of any one of the methods described above.

In some example embodiments of the present disclosure, there is provided a computer readable medium comprising program instructions for causing an apparatus to perform at least steps of any one of the methods described above. The computer readable medium may be a non-transitory computer readable medium in some embodiments.

In an eighth aspect, example embodiments of the present disclosure provide a computer readable medium comprising program instructions for causing an apparatus to perform at least the method in the second aspect described above. The computer readable medium may be a non-transitory computer readable medium in some embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method comprising:
obtaining a feature representation of an input data sample from a prediction model, the prediction model being configured to process input data with a periodicity, the input data sample being a sample of the input data generated at a point of time within a period;
determining first Fourier coefficients for a first component in a Fourier expansion by applying the feature representation into a first mapping model, the Fourier expansion being dependent on the point of time and the feature representation, and the Fourier expansion being of the periodicity;
determining second Fourier coefficients for a second component in the Fourier expansion by applying the feature representation into a second mapping model;
determining a Fourier expansion result based on the first Fourier coefficients and the second Fourier coefficients in the Fourier expansion; and
determining a prediction result for the input data sample based on the Fourier expansion result.

2. The method of claim 1, wherein the Fourier expansion comprises a truncated Fourier expansion with a predetermined number of terms, and the number of the first Fourier coefficients and the number of the second Fourier coefficients are based on the predetermined number.

3. The method of claim 2, wherein the first component is based on a sine function dependent on the point of time and having the periodicity, and the second component is based on a cosine function with the periodicity, and wherein determining the Fourier expansion result comprises:
determining a set of first component values for the first component by shifting a frequency of the sine function for the predetermined number of times;
determining a set of second component values for the second component by shifting a frequency of the cosine function for the predetermined number of times; and
determining the Fourier expansion result by multiplying the first Fourier coefficients with the first component values, respectively, and multiplying the second Fourier coefficients with the second component values.

4. The method of claim 3, wherein determining the Fourier expansion result by multiplying the first Fourier coefficients with the first component values, respectively, and multiplying the second Fourier coefficients with the second component values comprises:
calculating first products by multiplying the first Fourier coefficients with the first component values;
calculating second products by multiplying the second Fourier coefficients with the second component values;
mapping the first products to a first intermediate expansion result using a third mapping model, and mapping the second products to a second intermediate expansion result using a fourth mapping model; and
determining the Fourier expansion result by aggregating the first intermediate expansion result and the second intermediate expansion result.

5. The method of claim 1, wherein determining the prediction result for the input data sample based on the Fourier expansion result comprises:
determining a first intermediate prediction result from the Fourier expansion result;
obtaining a second intermediate prediction result generated from an output layer of the prediction model based on the feature representation; and
determining the prediction result by aggregating the first intermediate prediction result and the second intermediate prediction result.

6. The method of claim 1, wherein the prediction model comprises a plurality of sub-models configured to extract a plurality of feature representations from the input data sample, and wherein obtaining the feature representation comprises:
obtaining the plurality of feature representations from the plurality of sub-models;
generating the feature representation by aggregating the plurality of feature representations.

7. The method of claim 1, wherein the first mapping model and the second mapping model are constructed without activation functions.

8. A system, comprising:
at least one processor; and
at least one memory communicatively coupled to the at least one processor and comprising computer-readable instructions that upon execution by the at least one processor cause the at least one processor to perform acts comprising:
obtaining a feature representation of an input data sample from a prediction model, the prediction model being configured to process input data with a periodicity, the input data sample being a sample of the input data generated at a point of time within a period;
determining first Fourier coefficients for a first component in a Fourier expansion by applying the feature representation into a first mapping model, the Fourier expansion being dependent on the point of time and the feature representation, and the Fourier expansion being of the periodicity;
determining second Fourier coefficients for a second component in the Fourier expansion by applying the feature representation into a second mapping model;
determining a Fourier expansion result based on the first Fourier coefficients and the second Fourier coefficients in the Fourier expansion; and
determining a prediction result for the input data sample based on the Fourier expansion result.

9. The system of claim 8, wherein the Fourier expansion comprises a truncated Fourier expansion with a predetermined number of terms, and the number of the first Fourier coefficients and the number of the second Fourier coefficients are based on the predetermined number.

10. The system of claim 9, wherein the first component is based on a sine function dependent on the point of time and having the periodicity, and the second component is based on a cosine function with the periodicity, and wherein determining the Fourier expansion result comprises:
determining a set of first component values for the first component by shifting a frequency of the sine function for the predetermined number of times;
determining a set of second component values for the second component by shifting a frequency of the cosine function for the predetermined number of times; and
determining the Fourier expansion result by multiplying the first Fourier coefficients with the first component values, respectively, and multiplying the second Fourier coefficients with the second component values.

11. The system of claim 10, wherein determining the Fourier expansion result by multiplying the first Fourier coefficients with the first component values, respectively, and multiplying the second Fourier coefficients with the second component values comprises:
calculating first products by multiplying the first Fourier coefficients with the first component values;
calculating second products by multiplying the second Fourier coefficients with the second component values;
mapping the first products to a first intermediate expansion result using a third mapping model, and mapping the second products to a second intermediate expansion result using a fourth mapping model; and
determining the Fourier expansion result by aggregating the first intermediate expansion result and the second intermediate expansion result.

12. The system of claim 8, wherein determining the prediction result for the input data sample based on the Fourier expansion result comprises:
determining a first intermediate prediction result from the Fourier expansion result;
obtaining a second intermediate prediction result generated from an output layer of the prediction model based on the feature representation; and
determining the prediction result by aggregating the first intermediate prediction result and the second intermediate prediction result.

13. The system of claim 8, wherein the prediction model comprises a plurality of sub-models configured to extract a plurality of feature representations from the input data sample, and wherein obtaining the feature representation comprises:
obtaining the plurality of feature representations from the plurality of sub-models;
generating the feature representation by aggregating the plurality of feature representations.

14. The system of claim 8, wherein the first mapping model and the second mapping model are constructed without activation functions.

15. A non-transitory computer-readable storage medium, storing computer-readable instructions that upon execution by a computing device cause the computing device to perform acts comprising:
obtaining a feature representation of an input data sample from a prediction model, the prediction model being configured to process input data with a periodicity, the input data sample being a sample of the input data generated at a point of time within a period;
determining first Fourier coefficients for a first component in a Fourier expansion by applying the feature representation into a first mapping model, the Fourier expansion being dependent on the point of time and the feature representation, and the Fourier expansion being of the periodicity;
determining second Fourier coefficients for a second component in the Fourier expansion by applying the feature representation into a second mapping model;
determining a Fourier expansion result based on the first Fourier coefficients and the second Fourier coefficients in the Fourier expansion; and
determining a prediction result for the input data sample based on the Fourier expansion result.

16. The non-transitory computer-readable storage medium of claim 15, wherein the Fourier expansion comprises a truncated Fourier expansion with a predetermined number of terms, and the number of the first Fourier coefficients and the number of the second Fourier coefficients are based on the predetermined number.

17. The non-transitory computer-readable storage medium of claim 16, wherein the first component is based on a sine function dependent on the point of time and having the periodicity, and the second component is based on a cosine function with the periodicity, and wherein determining the Fourier expansion result comprises:
determining a set of first component values for the first component by shifting a frequency of the sine function for the predetermined number of times;
determining a set of second component values for the second component by shifting a frequency of the cosine function for the predetermined number of times; and
determining the Fourier expansion result by multiplying the first Fourier coefficients with the first component values, respectively, and multiplying the second Fourier coefficients with the second component values.

18. The non-transitory computer-readable storage medium of claim 17, wherein determining the Fourier expansion result by multiplying the first Fourier coefficients with the first component values, respectively, and multiplying the second Fourier coefficients with the second component values comprises:
calculating first products by multiplying the first Fourier coefficients with the first component values;
calculating second products by multiplying the second Fourier coefficients with the second component values;
mapping the first products to a first intermediate expansion result using a third mapping model, and mapping the second products to a second intermediate expansion result using a fourth mapping model; and
determining the Fourier expansion result by aggregating the first intermediate expansion result and the second intermediate expansion result.

19. The non-transitory computer-readable storage medium of claim 15, wherein determining the prediction result for the input data sample based on the Fourier expansion result comprises:
determining a first intermediate prediction result from the Fourier expansion result;
obtaining a second intermediate prediction result generated from an output layer of the prediction model based on the feature representation; and
determining the prediction result by aggregating the first intermediate prediction result and the second intermediate prediction result.

20. The non-transitory computer-readable storage medium of claim 15, wherein the prediction model comprises a plurality of sub-models configured to extract a plurality of feature representations from the input data sample, and wherein obtaining the feature representation comprises:
obtaining the plurality of feature representations from the plurality of sub-models;
generating the feature representation by aggregating the plurality of feature representations.
